(19) United States
(12) Patent Application Publication
(10) Pub. No.: US 2007/0004481 A1
(43) Pub. Date: Jan. 4, 2007

(54) Position/player specific game play (PSG) scheme for computer entertainment systems

(75) Inventors: Michael Patrick Riccio, Del Mar, CA (US); Gary Walter Weis, San Diego, CA (US); Brian Edward Sheehan, San Diego, CA (US); Cain Michael Quigley, San Diego, CA (US); Michael Kevin McMahon, Encinitas, CA (US); Thomas John Madigan, San Diego, CA (US); Ryan Mack, San Diego, CA (US); Joel Bernard Goodman, Vista, CA (US); Gerald Julio DeYoung, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment America Inc., Foster City, CA (US)

(21) Appl. No.: 11/297,113

(22) Filed: Dec. 8, 2005

Related U.S. Application Data
(60) Provisional application No. 60/693,866, filed on Jun. 24, 2005.

(51) Int. Cl. A63F 13/00

(52) U.S. Cl. 463/1

(57) ABSTRACT

A team sport entertainment simulation game-play innovation that enables the user to optionally choose the offensive or defensive player to control prior to the start of the play regardless of ball possession and to control that player until the play terminates, or for a portion of the play until the user cancels the player specific mode. The user is expected to perform the characteristic behavior of the controlled player's position (e.g. quarterback, running back, wide receiver, defensive back, etc. in the example of the team sport of football). Missions, which describe the characteristic behavior of the position, provide goals and incentives to play the position properly or in another manner. Upon completion of the tasks outlined in the missions the user is rewarded with player attribute upgrades that increase the player's odds of winning the game.

### CROSS-REFERENCE TO RELATED APPLICATIONS

This application claims the benefit of U.S. Provisional Patent Application No. 60/693,866, filed Jun. 24, 2005, entitled “POSITION/PLAYER SPECIFIC GAME PLAY (PSG) SCHEME FOR COMPUTER ENTERTAINMENT SYSTEMS,” the entire disclosure of which is incorporated herein by reference.

### BACKGROUND OF THE INVENTION

1. Field of the Invention

The present invention relates generally to computer entertainment systems, and more specifically to video games involving team sports.

2. Discussion of the Related Art

Computer entertainment game systems have become some of the most successful consumer electronics products to hit store shelves in recent years. Some of the video games that have been developed for such game systems involve team sports, such as for example football, basketball, hockey, baseball, etc. Such video games have becomes extremely popular.

It is with respect to these and other background information factors that the present invention has evolved.

### SUMMARY OF THE INVENTION

The present invention advantageously addresses the needs above as well as other needs by providing a method for use in a computer simulation. In one embodiment the method comprises steps of: receiving a user's choice of a player of a team to be controlled by the user; during execution of a play of the simulation, allowing the user to control the user's chosen player regardless of ball possession until the play terminates; and providing one or more incentives for the user to control the user's chosen player in a certain manner.

In another embodiment of the present invention there is provided a computer readable medium storing a computer program for causing a system to perform a method for use in a computer simulation. The method comprises steps of: receiving a user's choice of a player of a team to be controlled by the user; during execution of a play of the simulation, allowing the user to control the user's chosen player regardless of ball possession until the play terminates; and providing one or more incentives for the user to control the user's chosen player in a certain manner.

In another embodiment of the present invention there is provided a system for executing a computer simulation. The system comprises: means for receiving a user's choice of a player of a team to be controlled by the user; means for allowing the user to control the user's chosen player regardless of ball possession during execution of a play of the simulation until the play terminates; and means for providing one or more incentives for the user to control the user's chosen player in a certain manner.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a flow diagram illustrating a method that operates in accordance with an embodiment of the present invention;

FIG. 2 is a flow diagram illustrating a pre-play process that operates in accordance with an embodiment of the present invention;

FIG. 3 is a flow diagram illustrating an in-play process that operates in accordance with an embodiment of the present invention;

FIG. 4 is a flow diagram illustrating a post-play process that operates in accordance with an embodiment of the present invention; and

FIG. 5 is a block diagram illustrating a system capable of executing the methods shown in FIGS. 1-4 in accordance with an embodiment of the present invention.

Corresponding reference characters indicate corresponding components throughout the several views of the drawings.

### DETAILED DESCRIPTION

Virtually all previous football entertainment simulations offer the same game-play experience regarding the control of football players on the field. In offensive plays the user controls the player that has possession of the ball. As the possession of the ball transfers from player to player the user control transfers as well. In defensive plays the user typically controls the player closest to the ball carrier.

A football entertainment simulation made in accordance with an embodiment of the present invention enables the user to optionally choose the offensive or defensive player to control prior to the start of the play and to control that player regardless of ball possession until the play terminates, i.e. until the whistle is blown. The user is expected to perform the characteristic football behavior of the controlled player's position (e.g. quarterback, running back, wide receiver, defensive back, etc.). This type or mode of play is referred to herein as Player (or Position) Specific Game Play (PSG).

PSG can provide immersion by bringing the user down onto the field and placing him or her in the shoes of the players whom are the focal points for that week. In some embodiments, each week during the game the user may assume control of a single offensive player and/or a single defensive player for one or more plays, or even a portion of a play, when the units are on the field. When the user's offensive or defensive unit is on the field his or her player may be identified with a user-controlled cursor.

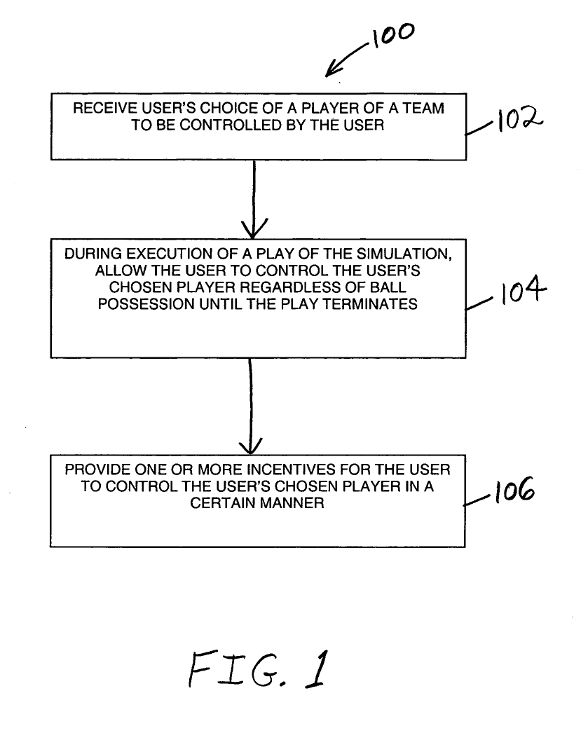

Referring to FIG. 1 there is illustrated a method 100 that operates in accordance with an embodiment of the present invention. The method 100 is one example of how a PSG system may be implemented that may be used in any type of computer simulation. For example, embodiments of the present invention may be implemented in computer or entertainment simulations, such as for example video games or the like.

In step 102 a system, such as for example an entertainment system, receives a user's choice of a player of a team to be controlled by the user. Any team sport may be simulated, and so the team may be any type of team, such as for example football, basketball, hockey, baseball, etc. The example embodiments described herein are designed and implemented for the team sport of football. It should be well understood, however, that embodiments of the present invention may be applied to any team sport.

As indicated by step 104, during execution of a play of the simulation, the user is allowed to control the user's chosen player regardless of ball possession until the play terminates. Finally, in step 106 one or more incentives are provided for the user to control the user's chosen player in a certain manner.

An example of such incentives are missions.

Missions, which describe the characteristic behavior of the position, provide a goals and incentives to play the position properly or in another manner that may suit the objectives of the user. Indeed, the missions help to provide a compelling reason for the user to choose to control a player other than the ball carrier throughout the course of the play. Game players (i.e. users) are motivated to complete missions written for specific football players or for the team. These missions outline behaviors that the football player should perform on-field.

For example, one of the user's goals may be to complete the on-field game objectives given to him or her by the owner prior to kick off. Exceeding the user's on-field goals where possible could result in additional awards or bonuses to the player/character, such as for example money and/or material items. It should be well understood, however, that the missions described herein are just one type of incentive and that other types of incentives may be used in accordance with various embodiments of the present invention.

Upon completion of the tasks outlined in the missions the user is rewarded with team or player attribute upgrades. An example of a team attribute is the owner's money. By completing team missions the owner will accumulate money, which contributes toward the goal of paying off his debt. Player attribute upgrades may include performance increases that increase the player's odds of winning the game. Player attributes may comprise power, athleticism, quickness, intelligence, and attitude, but other attributes may be used. Increasing player attributes results in player improvements manifested through a changed visual representation, improved capability and increased control. Higher player attributes relative to the opposing team results in a higher likelihood of winning games and thus contributes toward one ultimate goal of winning the season.

For embodiments of the present invention where the team sport comprises football, each weekly football game may have a set of missions that the user can accomplish, which enhances the game to be mission based football. These missions can be statistical based (e.g. complete 10 passes), physical based (e.g. perform a series of special moves), story based (e.g. take out the opposing coach on the sideline), or user defined (e.g. side bet on a score differential). Some missions need to be completed by specific players. Prior to entering the football game, off-field experiences can be used to setup some of the on-field missions (e.g. the sports book).

Thus, the user can control a specific player throughout the course of the play and is motivated to execute characteristic player position behavior through the pursuit of awards resulting from mission completions.

An optional feature that may be added to step 104 described above is to include the ability for the user to elect to no longer control the user's chosen player regardless of ball possession prior to termination of the play. Thus, if the user starts the play in PSG mode he or she can elect to cancel PSG mode before the play ends. Various embodiments of the present invention may be configured so that the user can make this election by canceling PSG mode and entering team play mode. Team play mode includes Team Offense mode (TO) and Team Defense mode (TD). If the user is on offense, choosing Team Offense mode results in the user controlling the player with possession of the ball (starting with the Quarterback). If the user is on defense, choosing Team Defense mode gives the user the option to switch to control the player nearest to the ball. Therefore, in some embodiments of the present invention, if the user chooses to play in a PSG mode the user will control that player until the whistle is blown. In other embodiments of the present invention, the user will have the ability to switch between PSG mode and team play mode during play execution.

One goal of the user in operating the football simulation may be to win the game. However, the user's objective may not only be to win the game but also to achieve on-field missions related to the team or to specific players. The user can satisfy missions by possessing the player and performing the appropriate mission actions. Some missions can be achieved through PSG mode, and some missions can be achieved through team play mode. And some missions, such as those where the user does not need to control a player from the start of the play, can still be completed while playing the game in a team play mode. This choice may be presented from the play-calling screen after choosing a play.

In choosing whether to play in PSG mode or in team play mode the user will typically consider whether achieving mission objectives for a specific player are more important to him or her or whether achieving a larger team related objective such as winning the game is more important. If trying to win the game is more important than trying to complete missions then the user should consider playing in team play mode. But if completing missions is more important to the user, then the user should consider choosing PSG mode. Then the user can choose a particular player in order to complete missions related to that player.

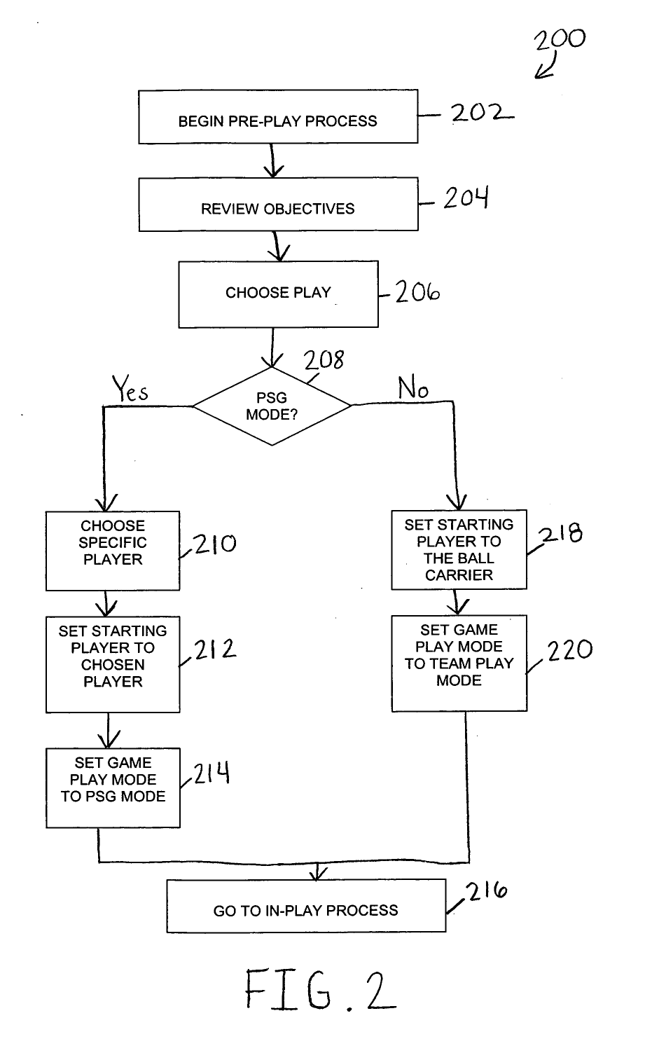

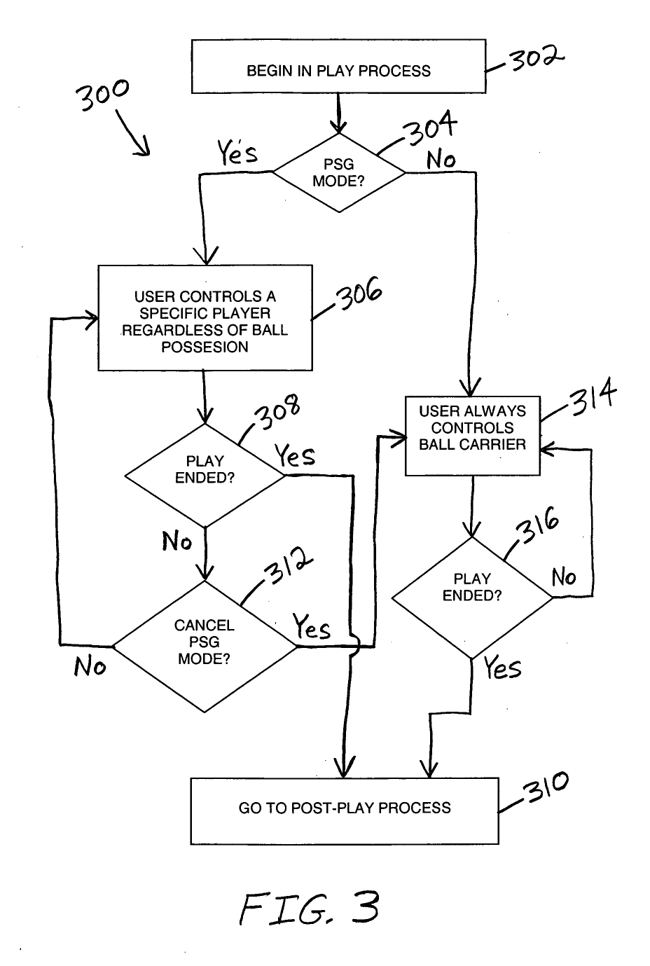

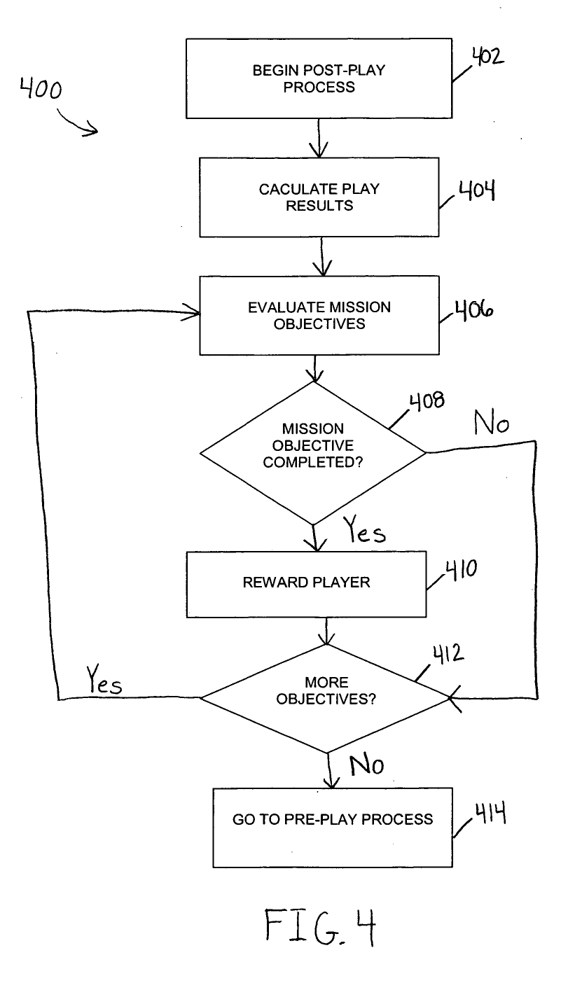

FIGS. 2, 3 and 4 illustrate another embodiment of the present invention and provide an example of the football game play and game flow. Specifically, FIG. 2 illustrates an example of a pre-play process 200, FIG. 3 illustrates an example of an in-play process 300, and FIG. 4 illustrates an example of a post-play process 400.

The pre-play process begins in step 202. In step 204 the user reviews the objectives, such as the missions, for all of the players on the team. That is, prior to the start of a play (while in the huddle) the user will be able to review the outstanding missions for his/her team. The missions may be written for specific players, and the list may be sorted based on the player's position. The user will review the list, review the current football situation and make a decision as to whether to play as a specific player or in team play mode.

In step 206 the user chooses a play for the team from the list of appropriate plays. For each football play the play selection screen may indicate those players that the user can choose to possess (PSG mode) or a team play mode (TO mode or TD mode). If the user is on offense the user will choose an offensive play and then choose to control a specific offensive player or Team Offense mode (action follows the ball carrier mode). If the user is on defense the user will choose a play and then choose to control a specific defensive player or Team Defense mode (ability to choose the player closest to the ball).

In step 208 the user selects whether to play a specific player (i.e. play in PSG mode) or play in team play mode. If the user chooses to play in PSG mode, the user selects a specific player in step 210. By way of example, the positions that the user may have the option to control in PSG mode may include: quarterback (QB), wide receiver (WR), running back (RB), defensive lineman (DL), linebacker (LB), defensive back (DB), and/or kicker (K). However, any combination of positions may be used. In one embodiment, a signature move for the player can only be invoked when the user chooses to play in PSG mode. In step 212 the starting player is set to the chosen player, and in step 214 the game play mode is set to PSG mode. Then in step 216 the simulation proceeds to the in-play process.

If on the other hand in step 208 the user chooses to play in team play mode, then in step 218 the starting player is set to the ball carrier. In step 220 the game play mode is set to team play mode, and from there the simulation proceeds to the in-play process in step 216.

Each position may have a set of controls specific to its pre-snap game play mechanics. Prior to the snap of the ball the user may have controls that will allow him or her to view his or her play assignment as well as execute any pre-snap adjustments. On offense if the user is either the running back or wide receiver he or she must respond to any audible calls from the quarterback by viewing his or her new play assignment and then executing that assignment after the ball is snapped. The same rule will apply to the defensive end and defensive back on defense, as the linebacker is the player to call plays and audibles for the defensive unit.

For example, the quarterback may call plays and audibles. The running back may have motion controls that enable the user to execute motion when it is part of the play design, or a play assignment button that allows the user to view his or her assignment per play call/audible. The wide receiver may have a capability to signal the quarterback as a “hot receiver”. The wide receiver may also have motion controls that enable the user to execute motion when it is part of the play design, or a play assignment button that allows the user to view his or her assignment per play call/audible. The defensive end may also have a play assignment button that allows the user to view his or her assignment per play call/audible. The linebacker may have the capability to call defensive plays, defensive audibles, linebacker shifts, and/or defensive lineman shifts. Finally, the defensive back may also have a play assignment button that allows the user to view his assignment per play call/audible. It should be understood that such pre-snap controls are optional and are not a requirement of the present invention.

In some embodiments, with a button press the user can send his or her player in motion (laterally), at which point the lateral movement is controlled by the user. While the player is moving laterally the user has the ability to send him up field (vertical). While the player is in motion, the user is listening for the snap count, at which point pressing up on the player controls sends him out on his route. Prematurely pressing up on the player controls may result in an “illegal procedure” penalty, so the user has to wait for the snap count.

The in-play process 300 begins in step 302 of FIG. 3. In step 304 the system determines whether or not PSG mode has been set. If so, the play proceeds in step 306 in PSG mode with the user controlling his or her specific chosen player as the play unfolds regardless of ball possession.

During the play the user is that player that he or she chose, such as for example the quarterback (QB), wide receiver (WR), running back (RB), defensive lineman (DL), linebacker (LB), defensive back (DB) and/or kicker (K). The user is at that position in the formation at the snap of the ball. In some embodiments only the quarterback position will have the ability to call plays in addition to quarterback game play mechanics. The user controlling his or her chosen player will generally have to execute the game play mechanics necessary to get his or her job done for that play. Each position may have a different set of associated moves. The associated moves may have intuitive and consistent controls enabling the user to execute them at any point during the play. Performing each play may only be a subset of a higher purpose, which is to complete the user's list of “Game Time” objectives given to him or her sometime prior to kick off. With everything the user has to do at his or her position, not all of it will count towards his or her list of objectives.

An example will now be provided for the scenario where the user chooses to play a defensive back (DB) position. In one embodiment, during a single play, the user controls the defensive back only. The user continues to play the defensive back until the play is dead, no matter the objective, or in some embodiments until the user cancels PSG mode. This means if the on-field objective for the current play is to deny the rushing first down and the running back gains a first down anyway, the play is not over although the objective was failed. The user must continue to play the game until the whistle has been blown signaling the play dead, or in some embodiments until the user cancels PSG mode. The game (camera) perspective may be from the defensive back position, with the camera positioned behind the defensive back. The user has control of the defensive back prior to the snap of the ball, i.e. the play is live at all times, and the user must execute off the snap.

With respect to mechanics, controller buttons may be provided that allow the defensive back to switch between backpedal coverage and full run coverage. Controller buttons may also be provided that allow the defensive back to hand fight by grabbing and/or holding a receiver. Successful execution results in a higher ball defense attempt, and poor execution results in the defensive back being out of synch with his coverage of the receiver. Controller buttons may also be provided that allow the defensive back to jam or push a receiver, which is a stronger move than the hand fighting move. Successful execution results in a higher ball defense attempt, and poor execution results in the defensive back being out of synch with his coverage of the receiver. Controller buttons may also be provided that allow the defensive back to look back at the ball in flight. Successful execution results in a higher ball defense attempt, and poor execution results in the defensive back being out of synch with his coverage of the receiver. And controller buttons may also be provided that allow the defensive back to deflect the ball while it is in route to the intended receiver, break up the catch once the ball comes into to contact with the receiver, or attempt an interception.

Mission objectives, which may be story related, are given prior to game time and throughout the game through cinematics and/or interface windows (text screens). The user may be required to complete the majority of the mission objectives, which can vary in number and frequency. Passing mission objectives will be determined via a completion percentage (for example, 8/10). And each position played may have a “check box” progress report that will allow the user to monitor the status of his or her objectives as the on-field football game progresses.

By using PSG mode the user's immersion and identification with his or her chosen player/character is heightened by the position focal point. In many embodiments the user plays from one position only and game choices are executed from that perspective only. By taking the specific player/character through a series of linear missions, the user will have a gratifying game experience derived from continually achieving objectives and a sense of accomplishment. Through story reinforcement and direction, each completed objective will carry a greater weight of purpose, magnified by the users game perspective from the specific position.

In step 308 the system determines whether or not the play has ended. If so, the simulation proceeds to the post-play process in step 310. If the play has not ended the system determines whether or not the user has canceled PSG mode in step 312. If not, the simulation returns to step 306 where the user continues in PSG mode controlling the specific chosen player as the play unfolds regardless of ball possession. As mentioned above, providing the user the ability to cancel PSG mode is an optional feature, and so step 312 is optional.

If in step 304 the system determines that PSG mode has not been set, or the user cancels PSG mode in step 312, the simulation proceeds to step 314 where the user always controls the ball carrier as the play unfolds in team play mode. In team play mode the ball carrier may change over the course of the play. In step 316 the system determines whether or not the play has ended. If so, the simulation proceeds to the post-play process in step 310. If the play has not ended the simulation returns to step 314 where the user continues to always control the ball carrier as the play unfolds in team play mode.

As the play unfolds the user will have various views of the play on the display screen of the entertainment system. Several different example camera implementations may be used for PSG mode in accordance with various embodiments of the present invention. For example, with respect to camera position, the game camera may remain from the third person vantage point of the player's position and it may always keep the player in the field of view. This means the camera will face the player's heading, allowing the user to view what is in front of the player. Camera behavior and positioning may be specific to each position prior to and after the snap of the ball. Furthermore, in PSG mode the user's experience and camera reflects the position of the player.

Camera controls may be dependent upon the game state and/or the position being played, with the user having very basic controls of the camera, which will allow him or her to peek back at the ball and/or QB anytime while defending against the pass. Player controls may be suspended when the look back feature is in use to eliminate user disorientation as the camera allows the user to view the ball while on flight. Or, in this situation, instead of the camera spinning around as the player's head quickly turns to look back, the camera may simply pull back to include the ball in the view while maintaining its heading up field.

A passing icon may be included in this view, which will enable the user (as the receiver/defender) to judge the flight of the ball while looking back and running in the opposite direction. The passing icon in this situation may appear on the field surface giving the user an idea as to heading of the ball and the optimal catch location. The passing icon may also have element that gives the user an idea as to how far away the ball is and how fast it is moving. Should the ball's direction or flight path change via deflection or wind, the icon may display this by constantly updating its location. The icon may work in conjunction with a graphical display of the route to be run.

Picture-in-picture (PIP) may be used to allow the camera system to maintain its focus on the user controlled player while still allowing the user to view the play as it plays out with a separate camera. The use of PIP is optional, however.

The post-play process 400 begins in step 402 of FIG. 4. In step 404 the system calculates the play results, and in step 406 the system evaluates the mission objectives. That is, the system evaluates whether or not the various objectives of the various missions were completed. In step 408 the system determines whether or not a particular mission objective has been completed. If so, the player is rewarded in step 410. Such a reward may comprise adding points to the player's attributes. Then in step 412 the system determines whether or not there are more mission objectives to evaluate, and if so, the simulation returns to step 406 to evaluate the additional objectives. If there are no more objectives to evaluate, the simulation proceeds back to the pre-play process in step 414.

In some embodiments, if a mission is completed while playing the football game attribute points will be immediately awarded with corresponding visual feedback. In the post-play process, if missions were completed, a celebration may ensue accounting the accomplished missions. Concurrently the camera may focus on the relevant players while they are awarded attribute upgrades with great fanfare, for example.

The following describes examples of player attributes that may be used. For example, in some embodiments of the present invention each player may have five attributes that can be modified over the course of a game. Successful or unsuccessful mission completion while on the field results in points added or subtracted from the attributes. Missions may affect one or more attributes. For example, how well the user performs beyond the necessary may dictate the rate at which the user's player's attributes progress. Player progression may be made necessary throughout the season because the objectives and the opponents get more difficult later on in the season. Furthermore, player progression may also be handled with off the field objectives.

Five example player attributes may include: power (strength); athleticism (physical finesse); quickness (acceleration); intellect (awareness); and signature moves.

By way of example, having points either added or subtracted from the power (strength) attribute can affect the player's ability to block by influencing the cycle selection to push a player, increase the chance of successful resolution, and allow the user to choose a power resolution. The power (strength) attribute can also affect the player's ability to tackle, such as allowing the user to choose power tackles, and allow the user to choose power special move animations. The power (strength) attribute can also affect the player's ability to receive greater crowd reactions.

Having points either added or subtracted from the athleticism (physical finesse) attribute can cause, for example, the player's cut turns to become shorter resulting in faster invocation and allow the user to choose finesse catching animations, finesse special move animations, finesse wide receiver waypoint animations, and power break tackles. The athleticism (physical finesse) attribute can also affect the player's ability to receive greater crowd reactions.

Having points either added or subtracted from the quickness (acceleration) attribute can, for example, increase the player's speed burst and add effects, improve successful outcome of special moves (e.g. spin, stiff arm), and increase the break-tackle invocation window.

Having points either added or subtracted from the intellect (awareness) attribute can, for example, provide the user with a graphical threat indication, improve the player's hearing by, for example, providing more audio queues and less crowd noise, and/or make the opponents go into slow motion to help the user. The player's vision may also be improved by, for example, making certain opponents more visually noticeable or visually indicating in advance the movements of certain opponents.

Having points either added or subtracted from the signature moves attribute can, for example, allow the user to invoke a signature move for the player more or less often.

An example of a team attribute that may be used is money. For example, as mentioned above a team attribute may be the owner's money. By completing team missions the owner will accumulate money, which contributes toward the goal of paying off his or her debt.

Many different types of missions may be used in accordance with various embodiments of the present invention. For example, story based missions may be used, such as injuring an opponent, taking a cheap shot on an opponent, instigating a fight with an opponent, taunting or humiliating an opponent, injuring a referee, bribing a referee (e.g. enlist cheerleaders), injuring the opposing coach on the sideline, hiring prostitutes for the opposing team, etc. In addition to storyline and character development, cinematics may be used to inform the user of character transition (player control) from week to week.

As another example, ball carrier based missions may be used, such as breaking tackles using various special moves, not allowing a particular player to tackle the user's player, performing a sequence of special moves, achieving a certain number of yards after initial contact, etc. Quarterback mission examples may include completing a certain number of passes. Wide receiver mission examples may include receiving a certain number of passes, achieving a certain number of yards after a catch, completing a pass reception in the end-zone for a touchdown, beating a particular defender on a route, etc. Running back mission examples may include running a motion route, averaging more than a certain number of yards per carry, running the ball for a touchdown, running the ball for a certain number of yards without any fumbles, leading a block for a running back through a hole, receiving a handoff/pitch, etc.

Other mission examples may include defensive lineman missions, linebacker missions, defensive back missions, kicker missions, celebration missions, celebration dance rhythm game missions, etc.

The following provides examples of PSG money missions by position that may be used in some embodiments of the present invention. The below Missions are primarily statistical and may be modified based on the storyline and the amount of time the user is scheduled to spend on the field each week. Non-statistical missions, such as for example injury and story, may also be added based on the story flow. The number of missions per position may be changed based on the amount of time the user is scheduled to be on the field each week.

In the below examples the missions appear each week based on which position/s (player/s) the user is focusing on for that week. So if the user is controlling the quarterback that week, then the quarterback missions will appear at the top of the list of missions. It should be well understood that the following are merely examples and that many variations and alternatives may be used in accordance with various embodiments of the present invention.

Week 1:

QB

Opponent—has blitzing defense.

QB Mission 1—Achieve 0 QB Fumbles.

QB Mission 2—Execute a Screen Play for positive gain.

QB Mission 3—Complete 3+ passes to the TE/Quick Slant route.

QB Mission 4—Score a passing or rushing TD.

QB Bonus Mission—Complete a 50+ yard pass.

Week 2:

DL

Opponent—strong running game, elusive QB.

DL Mission 1—Tackle the RB behind the LOS for a loss.

DL Mission 2—Record 4+ tackles.

DL Mission 3—Sack the QB.

DL Bonus Mission—Cause a QB fumble.

QB Mission 1—Throw 0 Interceptions.

QB Mission 2—Gain 15 rushing yards.

QB Mission 3—Gain 50+ passing yards.

Week 3:

WR

Opponent

WR Mission 1—Complete 3+ receptions.

WR Mission 2—Catch a 10+-yard pass.

WR Mission 3—Break a tackle.

WR Bonus Mission—Catch a TD pass.

DL Mission 1—Tackle the RB behind the LOS for a loss.

DL Mission 2—Record 5+ tackles.

DL Mission 3—Cause a fumble.

QB Mission 1—Maintain 55% Completion percentage.

QB Mission 2—Complete passes to 3 different receivers.

QB Mission 3—Score a RedZone TD.

Week 4:

LB

Opponent—power running game, great TE.

LB Mission 1—Tackle the RB behind the LOS for a loss.

LB Mission 2—Record 5+ tackles.

LB Mission 3—Deflect/Intercept 2 passes.

LB Mission 4—Allow 0 receptions in Zone Coverage (1^{st} Qtr).

LB Bonus Mission—Recover a Fumble.

DL Mission 1—Tackle the RB behind the LOS for a loss.

DL Mission 2—Record 3+ tackles.

DL Mission 3—Sack the QB.

DL Bonus Mission—Cause a QB fumble.

QB Mission 1—Complete the game with a QB rating of 85.0+.

QB Mission 2—Avoid being sacked more than 2 times.

QB Mission 3—Gain 60+ passing yards.

Week 5:

RB

Opponent—West Coast Offense, great LB, best run defense in the league.

RB Mission 1—Gain 75+ rushing yards.

RB Mission 2—Gain 30+YAC yards.

RB Mission 3—Gain 15+ yards receiving.

RB Mission 4—Execute 1 cut block (Pass Blocking).

RB Bonus Mission—Execute a “Spin” move to break a tackle and score TD.

WR Mission 1—Accumulate 35 receiving yards.

WR Mission 2—Successfully execute a down field cut block.

WR Mission 3—Execute a “Stiff Arm” for additional YAC yards.

WR Bonus Mission—Catch a 55+-yard pass.

LB Mission 1—Strip ball from the RB.

LB Mission 2—Record 8+ tackles.

LB Mission 3—Intercept 1 pass.

LB Mission 4—Allow 0 receptions in Zone Coverage (1^{st} Half).

DL Mission 1—Record 4+ tackles.

DL Mission 2—Sack the QB twice.

QB Mission 1—Gain 75+ passing yards.

QB Mission 2—Avoid being sacked.

Week 6:

CB

Opponent—Vertical passing game, big, physical WRs.

CB Mission 1—Hold assignments to 100 receiving yards or less.

CB Mission 2—Tackle the RB 3+ times.

CB Mission 3—Deflect/Intercept 1+ passes in the RedZone.

CB Mission 4—Shed blocker to tackle ball carrier (once).

CB Bonus Mission—Return interception/fumble for a TD.

RB Mission 1—Gain 90+ rushing yards.

RB Mission 2—Gain 50+ YAC yards.

RB Mission 3—Prevent your assignment from sacking the QB.

RB Mission 4—Execute a “Signature” move to break tackle and TD.

RB Bonus Mission—Score a 2-point conversion via run or pass.

WR Mission 1—Execute “Signature” move off the LOS to create separation (3×).

WR Mission 2—Create 10+ reception opportunities (QB throws you 10+ balls).

WR Mission 3—Accumulate 65 receiving yards.

WR Bonus Mission—Call “Hot” on a CB Blitz and make reception.

LB Mission 1—Create a QB fumble.

LB Mission 2—Tackle RB for a loss (3×).

LB Mission 3—Deflect/Intercept 3 passes.

LB Mission 4—Allow 3 or fewer receptions in Zone Coverage (Game).

LB Bonus Mission—Audible to play that results in an interception.

DL Mission 1—Knock down 1 pass.

DL Mission 2—Execute “Signature” move to sack the QB twice.

DL Mission 3—Record 6+ tackles.

DL Mission 4—Injure any opposing player.

DL Bonus Mission—Knock the QB out of the game.

QB Mission 1—Complete 5 passes on the “Sweet Spot”.

QB Mission 2—Execute “Sig.” move to avoid sack, then complete pass (2×).

QB Mission 3—Audible to a scoring play.

QB Mission 4—Draw defense off sides.

Week 7:

K

Opponent—Power running game, physical FB, fast RB (who often lines up in the slot), best Special Teams in the league with the most blocked kicks.

K Mission 1—Make every PAT.

K Mission 2—Make every FG from 30 yards or less.

K Bonus Mission—Stick a 30+ yard punt within the 15 yardline.

CB Mission 1—Allow 3 or fewer receptions in Zone Coverage.

CB Mission 2—No receptions greater than 15 yards allowed.

CB Mission 3—Sack or Intercept the QB 1+ times.

CB Mission 4—Cause 1 or more fumbles.

RB Mission 1—Gain 90+ rushing yards.

RB Mission 2—Successfully cut-block the blitzing LB (every opportunity).

RB Mission 3—Accumulate 35+ receiving yards.

RB Mission 4—Execute a “Signature” move to break tackle and TD.

WR Mission 1—Execute “Signature” move off the LOS to create separation (3×).

WR Mission 2—Execute an open field cut block on all down field block opportunity.

WR Mission 3-Accumulate 75 receiving yards.

WR Bonus Mission—Execute a “spin” and “juke” sp. Move to gain 15+ YAC Yards.

LB Mission 1—Hold opposing QB to 15 rushing yards or fewer.

LB Mission 2—Shift defensive alignment to result in QB sack.

LB Mission 3—Hold opposition to less than 100 rushing yards.

LB Mission 4—Get the offence to jump offsides.

LB Bonus Mission—Take out the opposing starting RB.

DL Mission 1—Execute Sig. Move to sack QB three times.

DL Mission 2—Execute Sig. move to tackle RB for loss twice.

DL Mission 3—Record 8+ tackles.

QB Mission 1—Draw the defense offsides.

QB Mission 2—Finish the game with a QB rating of 90.0+.

QB Mission 3—Audible to a scoring play.

Week 8:

QB—Khalid Woods/LB—Tiny Tagola.

Opponent—San Antonio Stangz (Blitzing defense).

QB Mission 1—Draw the defense offsides once per half.

QB Mission 2—Finish the game with a QB rating of 90.0+.

QB Mission 3—Audible to a scoring run play.

QB Mission 4—Maintain a 75%+ Redzone TD scoring efficiency.

QB Mission 5—Execute Sig. Move to escape sack and complete 15+ yard pass.

QB Bonus Mission—Avoid getting sacked the entire game (0 Sacks).

LB Mission 1—Create a QB fumble.

LB Mission 2—Break up 50% pass plays in your zone/s.

LB Mission 3—Execute Sig. Move to cause a fumble.

LB Mission 4—Record the most tackles on the team.

LB Bonus Mission—Audible to a defense that causes the offense to call T.O.

K Mission 1—Make every PAT.

K Mission 2—Make every FG from 35 yards or less.

K Bonus Mission—Stick a 35+ yard punt within the 10-yardline.

CB Mission 1—Hold assignment to 30 YAC yards or less in Man Coverage.

CB Mission 2—Allow 0 Redzone receptions.

CB Mission 3—Take out one of the referees.

CB Mission 4—Execute successful jam technique at least once per quarter.

RB Mission 1—Allow 0 sacks in passing blocking situations.

RB Mission 2—“Stiff Arm” and “Spin” move successfully for 25+YAC yards.

RB Mission 3—Accumulate 35+ receiving yards.

RB Mission 4—Execute a “Signature” move to break tackle and TD.

WR Mission 1—Complete game with most total receiving yards (opp. incl.).

WR Mission 2—Catch 80% of the passes thrown your way.

WR Mission 3—Avg. 20+ return yards on Sp. Teams.

DL Mission 1—Deflect 2 passes.

DL Mission 2—Execute Sig. move to cause RB fumble.

DL Bonus Mission—Score Safety.

Week 9:

WR

Opponent

WR Mission 1—Complete game with most receptions (opp. incl.).

WR Mission 2—Catch 80% of the passes thrown your way.

WR Mission 3—Catch a 2 pt. Conversion pass.

WR Mission 4—Catch 3 passes across the middle of the field.

WR Mission 5—Catch 2 passes during the 2 minute warning of the 2^{nd} half.

QB Mission 1—Complete 2 passes to each of the starting receivers.

QB Mission 2—Complete game with 30+ rushing yards.

QB Mission 3—Audible to a TD play (rushing or passing).

QB Mission 4—Complete game with 45+ passing yards to RBs.

QB Mission 5—Complete TD pass on a Max Protect audible play.

LB Mission 1—In Man Coverage hold assignment to less than 30 rec. yards.

LB Mission 2—Record 2+ QB sacks.

LB Mission 3—Audible to play for an interception.

LB Mission 4—Shift defense to record a tackle for a loss.

K Mission 1—Make every PAT.

K Mission 2—Make every FG from 35 yards or less.

K Bonus Mission—Stick a 35+ yard punt within the 7 yardline.

CB Mission 1—Cause a fumble.

CB Mission 2—Allow 0 receptions in Zone Coverage.

CB Mission 3—Hold assignment to 60 or fewer receiving yards.

CB Bonus Mission—Take out the starting receiver.

RB Mission 1—Gain 100+ rushing yards.

RB Mission 2—Allow 0 sacks in pass blocking situations.

DL Mission 1—Sack QB once per quarter.

DL Mission 2—Cause a QB fumble.

DL Bonus Mission—Record 2 tackle for a loss.

Week 10:

RB/CB

Opponent

RB Mission 1—Gain 100+ rushing yards.

RB Mission 2—“Stiff Arm” and “Spin” move successfully for 35+ YAC yards.

RB Mission 3—Score rushing TD within the RedZone.

RB Mission 4—Score TD reception within the RedZone.

RB Bonus Mission—Cut block the blitzing LB every opportunity.

CB Mission 1—Return an interception for a TD.

CB Mission 2—Successfully jam receiver at the LOS in Man Coverage.

CB Mission 3—Record a sack on the QB.

CB Mission 4—Record 3+ tackles on the opposing RB.

CB Bonus Mission—Knock number 1 receiver out of the game.

QB Mission 1—Maintain 100% efficiency on 3^{rd} down conversion (1^{st} half).

QB Mission 2—Complete pass to motion receiver for 25+ yards.

QB Mission 3—Complete 10+ yard pass to the deep out receiver.

QB Mission 4—Score a TD in the 2-minute warning of the 1^{st} or 2^{nd} half.

LB Mission 1—Audible to play that results in a sack.

LB Mission 2—Break up 50% pass plays in your zone/s.

LB Mission 3—Execute Sig. Move to cause a fumble.

LB Mission 4—Record the most tackles on the team.

LB Bonus Mission—Score a Safety.

K Mission 1—Make every PAT.

K Mission 2—Maintain a 40+ yard punting avg.

WR Mission 1—Maintain a 15+yards per catch avg.

WR Mission 2—Execute Sp. Moves to break multiple tackles for 25+ YAC.

WR Mission 3—Draw a defensive Pass Interference call on the defense.

DL Mission 1—Record 7+ tackles.

DL Mission 2—Recover 1 fumble.

DL Bonus Mission—Score Safety.

Week 11:

LB

Opponent

LB Mission 1—Tackle the RB behind the LOS for a loss.

LB Mission 2—Record 5+ tackles.

LB Mission 3—Deflect/Intercept 2 passes.

LB Mission 4—Allow 0 receptions in Zone Coverage (1^{st} Qtr).

LB Bonus Mission—Recover a Fumble.

RB Mission 1—Gain 90+ rushing yards.

RB Mission 2—Gain 50+ YAC yards.

RB Mission 3—Prevent your assignment from sacking the QB.

RB Mission 4—Execute a “Signature” move to break tackle and TD.

RB Bonus Mission—Score a 2-point conversion via run or pass.

CB Mission 1—Allow 3 or fewer receptions in Zone Coverage.

CB Mission 2—No receptions greater than 15 yards allowed.

CB Mission 3—Sack or Intercept the QB 1+ times.

CB Mission 4—Cause 1 or more fumbles.

QB Mission 1—Complete 5 passes on the “Sweet Spot”.

QB Mission 2—Execute “Sig.” move to avoid sack, then complete pass (2×).

QB Mission 3—Audible to a scoring play.

QB Mission 4—Draw defense off sides.

LB Mission 1—Tackle the RB behind the LOS for a loss.

LB Mission 2—Record 5+ tackles.

LB Mission 3—Deflect/Intercept 2 passes.

LB Mission 4—Allow 0 receptions in Zone Coverage (3^{rd} Qtr).

K Mission 1—Make every PAT.

K Mission 2—Make every FG from 40 yards or less.

K Bonus Mission—Stick a 35+ yard punt within the 5 yardline.

WR Mission 1—Execute “Signature” move off the LOS to create separation (3×).

WR Mission 2—Execute open field cut block on all down field block opportunity.

WR Mission 3-Accumulate 75 receiving yards.

WR Bonus Mission—Execute “spin” & “juke” sp. moves to gain 15+ YAC.

DL Mission 1—Record 4+ tackles.

DL Mission 2—Sack the QB twice.

Week 12:

K/CB

Opponent

K Mission 1—Make every PAT.

K Mission 2—Make every FG from 40 yards or less.

K Bonus Mission—Stick a 40+ yard punt within the 5 yard line.

CB Mission 1—Hold assignments to 75 receiving yards or less.

CB Mission 2—Tackle the RB behind the LOS.

CB Mission 3-Intercept 1+ passes in the RedZone.

CB Mission 4—Shed blocker to tackle ball carrier (once).

CB Bonus Mission—Record a QB sack.

LB Mission 1—Tackle the RB behind the LOS for a loss.

LB Mission 2—Record 5+ tackles.

LB Mission 3—Deflect/Intercept 2 passes.

LB Mission 4—Allow 0 receptions in Zone Coverage (1^{st} Qtr).

LB Bonus Mission—Recover a Fumble.

RB Mission 1—Gain 110+ rushing yards.

RB Mission 2—Prevent your assignment from sacking the QB.

QB Mission 1—Achieve 0 Fumbles.

QB Mission 2—Execute a Screen Play for 10+ yards.

QB Mission 3—Complete 3+ passes to the TE/Quick Slant route.

QB Mission 4—Score a rushing TD.

QB Bonus Mission—Complete a 35+-yard Post route.

LB Mission 1—Record 3+ tackles for a loss.

LB Mission 2—Record 7+ tackles.

LB Mission 3—Deflect 2+ passes.

LB Mission 4—Allow 0 receptions in Zone Coverage (2^{nd} half).

WR Mission 1—Record 100+ yard receiving.

WR Mission 2—Execute Sig. Move in RedZone to break tackle and score TD.

DL Mission 1—Record 7+ tackles.

DL Mission 2—Execute Sig. Move and record sack (3×).

Week 13:

DL/WR

Opponent—Power running game, physical FB, fast RB (who often lines up in the slot), best Special Teams in the league with the most blocked kicks.

DL Mission 1—Record 6+ tackles.

DL Mission 2—Execute Sig. Move and record sack (3×).

DL Mission 3—Record a tackle for a loss within opp. 15 yardline.

DL Mission 4—Execute Sig. Move and cause a fumble.

DL Bonus Mission—Knock QB out of game.

WR Mission 1—Record 100+ yard receiving.

WR Mission 2—Execute Sig. Move in RedZone to break tackle and score TD.

WR Mission 3—Record TD reception on a motion play.

WR Mission 4—Maintain a 10+-yard avg. per reception.

WR Bonus Mission—Score TD on a 55+-yard reception.

K Mission 1—Make every PAT.

K Mission 2—Maintain a 35+ yard punting avg.

CB Mission 1—Hold assignments to less than 35 YAC.

CB Mission 2—Tackle the RB behind the LOS.

CB Mission 3—Hold assignment to no TDs in the RedZone.

CB Mission 4—Shed blocker to tackle ball carrier (3×).

LB Mission 1—Audible to play and hold offense to less than 2-yard gain.

LB Mission 2—Audible to play for an interception.

LB Mission 3—Record 10+ tackles.

LB Mission 4—Allow 0 receptions in Zone Coverage (1^{st} Half).

RB Mission 1—Cut block pass blocking assignments.

RB Mission 2—Execute Sig. Move to break tackle for 15+ YAC yards.

RB Mission 3—Record 40+ receiving yards.

RB Mission 4—Gain 80+ rushing yards.

QB Mission 1—Audible to a TD running play (15+yards).

QB Mission 2—Complete game with 100.0+ QB rating.

QB Mission 3—Complete 6+ passes to the TE.

Week 14:

Position

Opponent

DL Mission 1—Record 5+ tackles.

DL Mission 2—Record 3+ deflected passes.

DL Mission 3—Record 2 tackles for a loss.

DL Bonus Mission—Recover 1+ fumbles.

WR Mission 1—Record 2+ TD receptions.

WR Mission 2—Record 10 receptions.

WR Mission 3—Execute 4 successful down field cut blocks.

WR Mission 4—Record 3+15+ yard receptions.

WR Bonus Mission—Execute “Sig.” Move+basic Sp. Move to score TD.

K Mission 1—Make every PAT.

K Mission 2—Make every FGA.

CB Mission 1—Deflect/Intercept 5+ pass attempts.

CB Mission 2—Record a sack on the QB.

CB Mission 3—Execute “Sig.” Move to take WR out of play.

CB Mission 4—Record 1+ RedZone interceptions.

LB Mission 1—Hold TE assignment to less than 10 YAC.

LB Mission 2—Record 7+ tackles.

LB Mission 3—Deflect 2+ passes.

LB Mission 4—Allow 0 receptions in Zone Coverage (1^{st} half).

RB Mission 1—Gain 100+ yards rushing.

RB Mission 2—Gain 45+ YAC rushing.

RB Mission 3—Execute “Sig.” Move+basic Sp. Move to score TD (2×).

RB Mission 4—Allow 0 sacks in pass blocking situations.

QB Mission 1—Draw defense offside 1+ times in 1^{st} and 2^{nd} half.

QB Mission 2—Complete game with 300+ yards passing.

QB Mission 3—Complete 2+ TD passes to the WRs.

QB Mission 4—Complete 1+ TD passes to the RB.

Week 15:

Playoffs Week.

DL Mission 1—Record 3+ tackles for a loss.

DL Mission 2—Record 3+ QB sacks.

DL Mission 3—Record 1+ Fumble Recoveries.

DL Bonus Mission—Knock opposing RB out of the game.

WR Mission 1—Record 100+ receiving yards.

WR Mission 2—Record 7+ receptions.

WR Mission 3—Execute “Sig.” Move+Sp. Move to record 50+ YAC.

WR Mission 4—Record 3+ down field blocks.

WR Bonus Mission—Execute “Sig.” Move+basic Sp. Move to score TD (2×).

K Mission 1—Make every PAT.

K Mission 2—Make 50+ Yard FG.

CB Mission 1—Intercept 2+ passes.

CB Mission 2—Execute “Sig.” Move to cause a fumble.

CB Mission 3—Allow 0 RedZone receptions all game.

CB Mission 4—Record 1+ RedZone interceptions.

LB Mission 1—Hold assignment to less than 5 receptions in Man Coverage.

LB Mission 2—Record 10+ tackles.

LB Mission 3—Record a tackle for a loss in the Redzone.

LB Mission 4—Audible to defense for a sack.

RB Mission 1—Gain 100+ rushing yards.

RB Mission 2—“Stiff Arm” and “Spin” move successfully for 35+ YAC yards.

RB Mission 3—Score rushing TD within the RedZone.

RB Mission 4—Score TD reception within the RedZone.

RB Bonus Mission—Cut block the blitzing LB every opportunity.

QB Mission 1—Finish the game with a 100.0+ QB rating.

QB Mission 2—Finish the game with 85.0+% RedZone scoring Efficiency.

QB Mission 3—Avoid being sacked 2+ times.

QB Mission 4—Complete a 50+-yard TD pass.

Week 16:

Championship Week. Mission assignments for this week are optional.

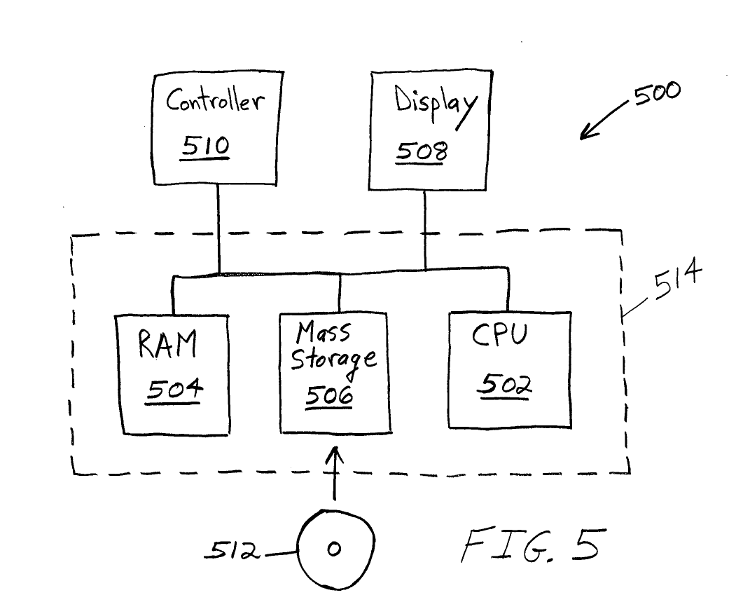

By way of example, embodiments of the present invention may be implemented in video game applications of the type executed by video game consoles and other computer entertainment devices. That is, the methods and techniques described herein may be utilized and run on many different types of computers, graphics workstations, video game systems and consoles, and the like. Referring to FIG. 5 there is illustrated such a system 500 that may be used to run the methods and techniques described herein. The system 500 may include a central processing unit (CPU) 502, a random access memory (RAM) 504, a mass storage unit 506, such as a disk drive, a display monitor 508, and a hand held controller 510 or similar device. It should be well understood that many other components may be included in the system 500.

The CPU 502 can be used to execute the steps of the methods and techniques described herein, and the video games or other simulations can be rendered on the display monitor 508. Removable storage media 512 may optionally be used with the mass storage unit 506. The removable storage media 512 may comprise a DVD, CD, floppy disk, USB storage device, or other similar computer readable medium or device. The removable storage media 512 may be used for storing code or a program that implements the methods and techniques described herein, such as a video game or other simulation. Either all or a portion of the system 500 may be embodied in a device 514, such as for example a computer or video game console or other entertainment system.

The hand held controller 510 may be coupled to the rest of the system 500 by either a wired or wireless connection. By way of example, the hand held controller 510 may include Square, Triangle, Circle and X buttons, as well as R1, R2, L1 and L2 buttons, up, down, right, and left arrow pad buttons, and right and left analog controls. By way of further example, if implementation is for an entertainment system, then an example of the button assignments for the hand held controller 510 for the player control modes may be as follows:

Post-Snap Ball Carrier mode: Square=Spin Move; Triangle=Hurdle; Circle=Context Sensitive Evade Tackle (e.g. stiff-arm or shoulder-charge); X=Speed Burst; L1=Juke Left; R1=Juke Right; L2+?=Signature move. As alternatives/options, a dive may be inserted, taking a knee may be context sensitive, and on-offs for stiff-arm and shoulder-charge may be inserted.

Pre-Snap Receiver/Running Back Mode: Triangle=Hot Route, which allows the user to abandon his current route and run a quick slant, in the event that he suspects his assigned defender is going to blitz the QB; R2=View Play Assignment, which allows the user to display the route; D-Pad (Down)=Enable Motion, which causes a step back and go into motion mode; Left Analog=Navigate Motion Player; L1=Strafe.

Post-Snap Receiver/Running Back Mode: Square=Attempt Cut Block; Triangle=Catch Pass/Catch Pitch/Call for Pass (while ball is with QB); Circle=Attempt Open Field Block (run play)/Shove (pass play), Context Sensitive Evade Block (evade DB Jam); X=Speed Burst; L1=Strafe; L2+?=Signature move. As alternatives/options, future assignments may include Break Down Move/Block Delay and Release.

Pre-Snap Quarterback Mode: Square=Audible; Triangle=No Huddle (pre-huddle); Circle=No Huddle Spike Ball (pre-huddle); X=Hurry to Line, and Snap the Ball (after set); R2=Pre-read Offensive Routes.

Post-Snap Quarterback Mode: Square=Pass, Bullet Pass (hold), Pump Fake (double tap); Triangle=Pass, Bullet Pass (hold), Pump Fake (double tap); Circle=Pass, Bullet Pass (hold), Pump Fake (double tap); X=Evade; L1=Pass, Bullet Pass (hold), Pump Fake (double tap); R1=Pass, Bullet Pass (hold), Pump Fake (double tap); R2=Throw Ball Away; R-Analog=Total Control Passing; L2+?=Signature move.

Post-Snap Ball Recovery Mode: Square=Attempt Cut Block; Triangle=Recover Ball (Scoop, Catch, or Dive); Circle=Attempt Open Field Block, Context Sensitive Evade Block; X=Speed Burst; L2=Switch to Closest Player to Ball (NON-PSG Mode); L2+?=Signature move.

Pre-Snap Defensive Mode: Square=Audible (PSG LB or Team Defense); X+L2=Fire Off Line (hold until snap); L1=Strafe; L2+DPAD or Left-Analog=Select Defender; R2=Player Assignments/Routes, which allows the user to read his man or zone coverages; DPAD=Shift Line (LB Call Shift, Others Respond to Shift).

Post-Snap Defensive Mode: Square=Tackle, which allows the user to execute a tackle; Triangle=Deflect/Intercept Pass; Circle=Jam (special case open field block), Context Sensitive Evade Block; X=Speed burst; L1=Strafe; L2=Switch to Closest Defender (Team Defense Mode); L2+?=Signature move (PSG Mode).

Post-Snap Defensive Block Engaged Mode: Triangle=Ball Deflection Attempt; Circle+L-Stick=Context Sensitive Resolve Block; L2=Switch to Closest Defender (Team Defense Mode); L2+?=Signature move (PSG Mode).

It should be well understood that the above-described example button assignments for the player control modes on the hand-held controller 510 are merely examples and that many variations and other implementation may be used in accordance with various embodiments of the present invention.

While the invention herein disclosed has been described by means of specific embodiments and applications thereof, numerous modifications and variations could be made thereto by those skilled in the art without departing from the scope of the invention set forth in the claims.

What is claimed is:

1. A method for use in a computer simulation, the method comprising steps of:
receiving a user's choice of a player of a team to be controlled by the user;
during execution of a play of the simulation, allowing the user to control the user's chosen player regardless of ball possession until the play terminates; and
providing one or more incentives for the user to control the user's chosen player in a certain manner.

2. A method in accordance with claim 1, wherein the step of allowing the user to control the user's chosen player regardless of ball possession until the play terminates comprises the step of:
during execution of the play of the simulation, allowing the user to elect to no longer control the user's chosen player regardless of ball possession.

3. A method in accordance with claim 2, wherein the user elects to no longer control the user's chosen player regardless of ball possession by canceling a player specific mode of operation of the simulation.

4. A method in accordance with claim 2, wherein the user elects to no longer control the user's chosen player regardless of ball possession by entering a team play mode of operation of the simulation.

5. A method in accordance with claim 1, wherein the incentives comprise missions.

6. A method in accordance with claim 5, wherein the missions comprise tasks to be completed by the user's chosen player.

7. A method in accordance with claim 6, wherein completion of the tasks results in attribute upgrades for the user's chosen player.

8. A method in accordance with claim 1, further comprising the step of:
receiving the user's choice of operating the simulation in a player specific mode of operation or a team mode of operation.

9. A method in accordance with claim 1, wherein the team comprises a football team.

10. A computer readable medium storing a computer program for causing a system to perform a method for use in a computer simulation, the method comprising steps of:
receiving a user's choice of a player of a team to be controlled by the user;
during execution of a play of the simulation, allowing the user to control the user's chosen player regardless of ball possession until the play terminates; and
providing one or more incentives for the user to control the user's chosen player in a certain manner.

11. A computer readable medium in accordance with claim 10, wherein the step of allowing the user to control the user's chosen player regardless of ball possession until the play terminates comprises the step of:
during execution of the play of the simulation, allowing the user to elect to no longer control the user's chosen player regardless of ball possession.

12. A computer readable medium in accordance with claim 11, wherein the user elects to no longer control the user's chosen player regardless of ball possession by canceling a player specific mode of operation of the simulation.

13. A computer readable medium in accordance with claim 11, wherein the user elects to no longer control the user's chosen player regardless of ball possession by entering a team play mode of operation of the simulation.

14. A computer readable medium in accordance with claim 10, wherein the incentives comprise missions.

15. A computer readable medium in accordance with claim 14, wherein the missions comprise tasks to be completed by the user's chosen player.

16. A computer readable medium in accordance with claim 15, wherein completion of the tasks results in attribute upgrades for the user's chosen player.

17. A computer readable medium in accordance with claim 10, wherein the method further comprises the step of:
receiving the user's choice of operating the simulation in a player specific mode of operation or a team mode of operation.

18. A computer readable medium in accordance with claim 10, wherein the team comprises a football team.

19. A system for executing a computer simulation, comprising:
means for receiving a user's choice of a player of a team to be controlled by the user;
means for allowing the user to control the user's chosen player regardless of ball possession during execution of a play of the simulation until the play terminates; and
means for providing one or more incentives for the user to control the user's chosen player in a certain manner.

20. A system in accordance with claim 19, wherein the means for allowing the user to control the user's chosen player regardless of ball possession comprises:
means for allowing the user to elect to no longer control the user's chosen player regardless of ball possession during execution of the play of the simulation.

21. A system in accordance with claim 20, wherein the user elects to no longer control the user's chosen player regardless of ball possession by canceling a player specific mode of operation of the simulation.

22. A system in accordance with claim 20, wherein the user elects to no longer control the user's chosen player regardless of ball possession by entering a team play mode of operation of the simulation.

23. A system in accordance with claim 19, wherein the incentives comprise missions.

24. A system in accordance with claim 23, wherein the missions comprise tasks to be completed by the user's chosen player.

25. A system in accordance with claim 24, wherein completion of the tasks results in attribute upgrades for the user's chosen player.

26. A system in accordance with claim 19, further comprising:
means for receiving the user's choice of operating the simulation in a player specific mode of operation or a team mode of operation.

27. A system in accordance with claim 19, wherein the team comprises a football team.
